(19) United States
(12) Patent Application Publication
(10) Pub. No.: US 2018/0185916 A1
(43) Pub. Date: Jul. 5, 2018

(54) Fabrication Method Using Foam Elements, and Structures Fabricated Using The Method

(71) Applicant: NOV Downhole Eurasia Limited, Stonehouse (GB)

(72) Inventors: Mark Jonathan FRANCIS, Randwick (GB); Marc A. BRYANT, Bradley Stoke (GB)

(73) Assignee: NOV Downhole Eurasia Limited, Stonehouse (GB)

(21) Appl. No.: 15/741,587

(22) PCT Filed: Jul. 8, 2016
(86) PCT No.: PCT/GB2016/052063

§ 371 Date: Jan. 3, 2018

(30) Foreign Application Priority Data
Jul. 10, 2015 (GB) 1512095.9

(51) Int. Cl. B22F 3/11; B22F 3/24; C22C 29/08; B33Y 80/00; E21B 10/46

(52) U.S. Cl. CPC B22F 3/1137; B22F 3/24; C22C 29/08; B22F 3/1055; E21B 10/46; B22F 2003/242; B22F 2003/244; B33Y 80/00

(57) ABSTRACT

A method of fabricating a structure having an open cell foam element includes providing an open cell foam element of metallic, diamond, ceramic and/or refractory material form, and/or having one or more metallic, diamond, ceramic and/or refractory material coatings, the foam element defining a plurality of interconnected cells. The method further includes locating a material within the cells, and treating the material, in situ, by sintering and/or infiltration, to form a continuous mesh or lattice structure that extends within and through the cells of the open cell foam element. Structures fabricated using the method are also described.

### CROSS REFERENCE TO RELATED APPLICATIONS

This application is a 35 U.S.C. § 371 national stage application of PCT/GB2016/052063 filed Jul. 8, 2016 and entitled “Fabrication Method Using Foam Elements, and Structures Fabricated Using The Method”, and United Kingdom Patent Application No. 1512095.9 filed Jul. 10, 2015, which are incorporated herein by reference in their entirety for all purposes.

### STATEMENT REGARDING FEDERALLY SPONSORED RESEARCH OR DEVELOPMENT

Not applicable.

### TECHNOLOGICAL FIELD

None

### BACKGROUND

This disclosure relates to a method of fabrication of structures, for example cutters for rotary drill bits, bit bodies or other downhole tools, or for use in other applications, in which a foamed material element is incorporated or used in the fabrication thereof, and to structures fabricated using the method.

One form of rotary drill bit in common use comprises a bit body to which a series of polycrystalline diamond compact cutters is secured. Each cutter takes the form of a table of polycrystalline diamond integrally bonded to a substrate, and formed by placing a substrate, for example of tungsten carbide form, and diamond powder into a container and exposing the materials within the container to high temperature, high pressure conditions resulting in bonds forming between the diamond material particles to form the polycrystalline diamond table, and in the table being integrally bonded to the substrate. A catalyst such as cobalt is typically provided to promote the formation of the desired structure. The catalyst may be drawn from the substrate, or could comprise a separate material located within the container.

Methods of the general type outlined hereinbefore are widely known and are described in a large number of documents. By way of example, WO2010/092540, US2012/085585 and GB2480384 all describe this general type of fabrication method, and structures fabricated using this type of method.

An alternative form of drill bit includes a bit body in which diamond materials are impregnated, at least in some of the parts thereof that, in use, are expected to bear against the formation material to be drilled.

### SUMMARY OF THE DISCLOSURE

Described herein are structures, for example in the form of cutters or bit bodies, incorporating or using foam elements to enhance certain of the properties thereof.

According to the present disclosure there is provided a method of fabrication of a structure, the method comprising the steps of providing an open cell foam element of metallic, diamond, ceramic and/or refractory material form, and/or having one or more metallic, diamond, ceramic and/or refractory material coatings, the element defining a plurality of interconnected cells, locating a material within the cells, and treating the material, in situ, by sintering and/or infiltration, to form a continuous lattice structure extending within and through the cells of the open cell foam element.

According to another aspect of the disclosure, there is provided a structure comprising an open cell foam element of metallic, diamond, ceramic and/or refractory material form, and/or provided with one or more metallic, diamond, ceramic and/or refractory material coatings, the element defining a plurality of interconnected cells, and a material located within the cells, the material having been treated, in situ, by sintering and/or infiltration, to form a continuous mesh or lattice structure extending within and through the cells of the open cell foam element. The structure may be fabricated using the method set out hereinbefore.

The cells of the foam element may be irregularly arranged, in which case the mesh or lattice will be an irregular mesh or lattice. Alternatively, the cells of the foam element may be regularly arranged, in which case the mesh or lattice structure may also be of regular form. In the description herein, the term “lattice” will be used to describe such a structure, regardless as to whether the structure is of regular or irregular form.

According to another aspect of the disclosure there is provided a structure comprising a metallic material open cell foam element defining a plurality of interconnected cells, tungsten carbide material located within the cells, and an alloy infiltrated into the tungsten carbide material in the cells such that the infiltrated tungsten carbide material forms a continuous lattice structure extending within and through the cells of the open cell foam element.

The open cell foam material element may be provided with a coating, for example a ceramic or tungsten carbide coating. By way of example, this may be achieved using a CVD process.

One application in which the embodiments that are described herein may be employed is in the manufacture of bit bodies. By way of example, the foam material element may be incorporated into a part of the bit body that is desired to be of increased strength, during the fabrication of the bit body.

The disclosure also relates to a manufacturing method for use in the manufacture of such a structure, the method comprising the steps of providing a metallic material open cell foam material element defining a plurality of interconnected cells, locating a tungsten carbide material within the cells, and infiltrating an alloy into the tungsten carbide material in the cells such that the infiltrated tungsten carbide material forms a continuous lattice structure extending within and through the cells of the open cell foam element.

According to another aspect of the disclosure, there is provided a structure comprising a metallic or refractory material open cell foam element defining a plurality of interconnected cells and diamond material located within the cells, the diamond material having been sintered, in situ, to form a lattice structure extending within the cells of the open cell foam element.

The open cell foam material may be provided with a coating, for example of ceramic or tungsten carbide form.

The disclosure also relates to a manufacturing method for use in the manufacture of such a structure, the method comprising the steps of providing a metallic or refractory material open cell foam element defining a plurality of interconnected cells, locating a diamond material within the cells, and sintering the diamond material, in situ, to form a lattice structure extending within the cells of the open cell foam element.

Where the element is of a metallic material, the metallic material may be leached after sintering of the diamond material to leave a porous diamond lattice structure.

One application in which the embodiments that are disclosed herein may be employed is in the fabrication of cutters. By way of example, the foam element may form part of a substrate, the presence of the diamond material lattice extending through and within the cells of the foam element locking the diamond material lattice in position and so increasing the resistance to separation of the diamond material from the substrate. The foam element may further serve to enhance the conduction of heat from the diamond material. Alternatively, where the foam material element is leached after sintering of the diamond, the porous nature of the diamond structure may allow enhanced cooling of the cutter by enabling coolant material to flow through the diamond material. In an alternative application, the porous diamond material so formed could be used as a filter or the like.

According to another aspect of the disclosure, there is provided a structure comprising an open cell foam diamond material element defining a plurality of interconnected cells, and a second diamond material located within the cells, the second diamond material having been sintered, in situ, to form a continuous lattice structure extending within the cells of the open cell foam element.

The open cell foam diamond material element may take the form of a carbon or refractory foam material element upon which a diamond material layer or coating has been deposited, for example by a CVD process.

Such a structure may be used in, for example, the fabrication of cutters of enhanced thermal conductivity.

The method also relates to a method of manufacture of such a structure, the method comprising the steps of providing a structure comprising an open cell foam diamond material element defining a plurality of interconnected cells, locating a second diamond material within the cells, and sintering the second diamond material, in situ, to form a lattice structure extending within the cells of the open cell foam element.

According to yet another aspect of the disclosure, there is provided a structure comprising a diamond material open cell foam element defining a plurality of interconnected cells, and a material infiltrated into the cells such that the infiltrated material forms a continuous lattice structure extending within and through the cells of the open cell foam element.

The material may comprise a metal, but could alternatively comprise a resin in some applications.

The open cell foam diamond material element may take the form of a carbon or refractory foam material element upon which a diamond material layer or coating has been deposited, for example by a CVD process.

Such a structure may be used as an abrasive material.

Prior to infiltration of the cells with the metal, a powder such as tungsten carbide powder may be located therein.

The disclosure also relates to a method of manufacture of such a structure, the method comprising providing a diamond material open cell foam element defining a plurality of interconnected cells, and infiltrating a material into the cells such that the infiltrated material forms a continuous lattice structure extending within and through the cells of the open cell foam element.

In any of the above described arrangements, the foam element may be of substantially uniform density. Alternatively, it may be of graded form. By way of example, it may be of increased density adjacent a periphery thereof, and of reduced density remote from the periphery. This may be achieved by, for example, deformation of an initially substantially uniform element prior to the application of the powder material thereto.

### BRIEF DESCRIPTION OF THE DRAWINGS

The exemplary embodiments that are disclosed herein are best understood with reference to the accompanying drawings, in which:

FIG. 1 is a diagrammatic representation illustrating a structure made in accordance with a first exemplary embodiment of this disclosure;

FIG. 2 is a representation of the foam element used in the formation of the structure of FIG. 1;

FIGS. 3 and 4 are representations illustrating the structure forming part of cutters;

FIG. 5 is a representation illustrating the structure forming part of a drill bit body; and

FIG. 6 represents an abrasive material incorporating such a structure.

### DETAILED DESCRIPTION OF THE DISCLOSED EXEMPLARY EMBODIMENTS

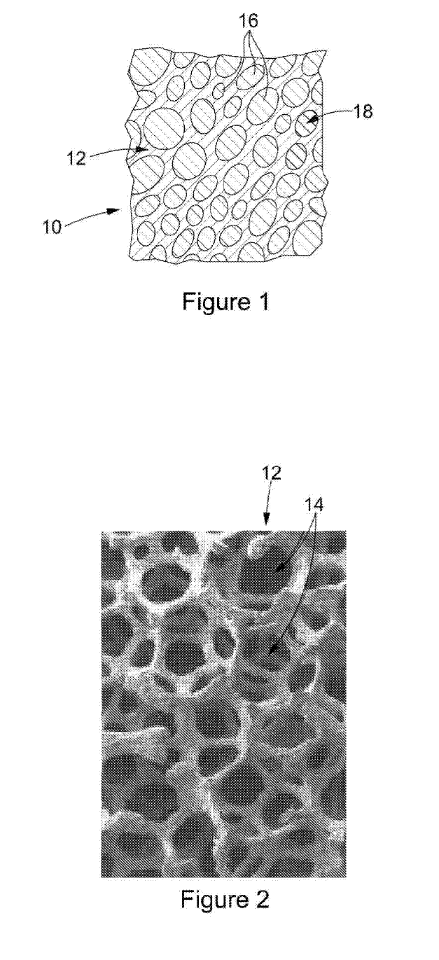

Referring firstly to FIGS. 1 and 2, a structure 10 is illustrated that comprises an element 12 of an open cell foam material. The element 12 may be formed using any suitable technique to result in the formation of a continuous series of interconnected cells 14 that extend through the element 12. By way of example, it may be formed by the pyrolysis of organic materials to leave a graphite foam or skeleton to which a desired coating may be applied, for example by the use of a CVD process. Alternatively, the foam element 12 could be produced using a 3D printing technique or by any other suitable technique. It will be appreciated that the manner in which the foam element 12 is formed is not of relevance to the claimed invention, and that the claimed invention is applicable to the use of such foam elements regardless as to how they are formed. In this example, the element 12 is of a metallic material such a nickel, formed by the deposition of a nickel coating onto such a graphite foam structure. A different material coating may be applied to the element 12. For example, a CVD process may be used to deposit a tungsten carbide material coating thereto. The coating entirely coats the material of the element 12, not just the exposed surfaces of the element 12, and so is deposited to at least parts of the element 12 via the cells 14.

A powder material 16, in this case in the form of tungsten carbide powder, is located within the cells 14, the powder material 16 having been treated to form the powder material 16 into a solid continuous lattice 18. In this example, the treatment comprises infiltrating the powder material 16 using a molten alloy which, once cooled, results in the powder material 16 forming the solid, continuous lattice 18 which extends within and through the cells 14 of the foam element 12. The lattice 18 is intermeshed with the element 12 and cannot be separated therefrom without damage to the lattice 18 and/or element 12.

It has been found that despite the cells 14 of the element 12 being of small dimensions, substantially complete packing thereof with the powder material can readily be achieved simply by pouring the powder material 16 into the element 12. Indeed, it is thought that the presence of the element 12 may aid packing in some circumstances by reducing ‘bridging’ effects.

Whilst the description hereinbefore is of a structure in which tungsten carbide powder is located within the cells of the element 12 and is infiltrated by a molten alloy to form a continuous lattice structure, it will be appreciated that other materials and other processes may be used.

By way of example, instead of using tungsten carbide powder, the powder material 16 may take the form of diamond powder, and instead of treating the powder material 16 by infiltration thereof with a molten alloy, the treatment may take the form of sintering the powder material to form a solid continuous lattice extending within and through the cells of the element 12. In such an arrangement, the element 12 and diamond material powder are located within a container and subject to high temperature, high pressure conditions to result in the formation of a continuous polycrystalline diamond lattice extending within and through the cells of the element 12. In order to promote the formation of the polycrystalline diamond lattice, a suitable catalyst, for example in the form of cobalt, may be located in the container, along with the diamond powder. Typically, the catalyst is drawn from the substrate material during the sintering process.

Furthermore, whilst the description hereinbefore is of an arrangement in which the foam element 12 is of nickel or nickel coated form, a wide range of other materials may be used. These include other metals, ceramics, refractories such as tungsten and graphite, and arrangements to which a diamond material coating has been applied, for example using a CVD technique. Whilst elements 12 may be used in which a coating in the form of one or more layers of a single material are applied, coatings made up of layers of two or more different materials may be used. By way of example, the element could comprise a graphite structure to which a nickel coating is applied, a diamond material coating being applied over the nickel coating.

It will be appreciated from the description hereinbefore that a wide range of combinations of materials are possible. By way of example, the element 12 may be of metallic form and the powder 16 may be of metallic form, treated by infiltration, as described hereinbefore. Alternatively, the element 12 may be of metallic form and the powder 16 may be of diamond form, treated by sintering. Further alternatives include the use of an element 12 of diamond material form, with the powder 16 comprising either a diamond material powder or a metallic material powder, treatment being by sintering or by infiltration as appropriate. The selection of materials used, and the treatment method, is dependent upon the intended application in which the structure is to be used and the requirements thereof.

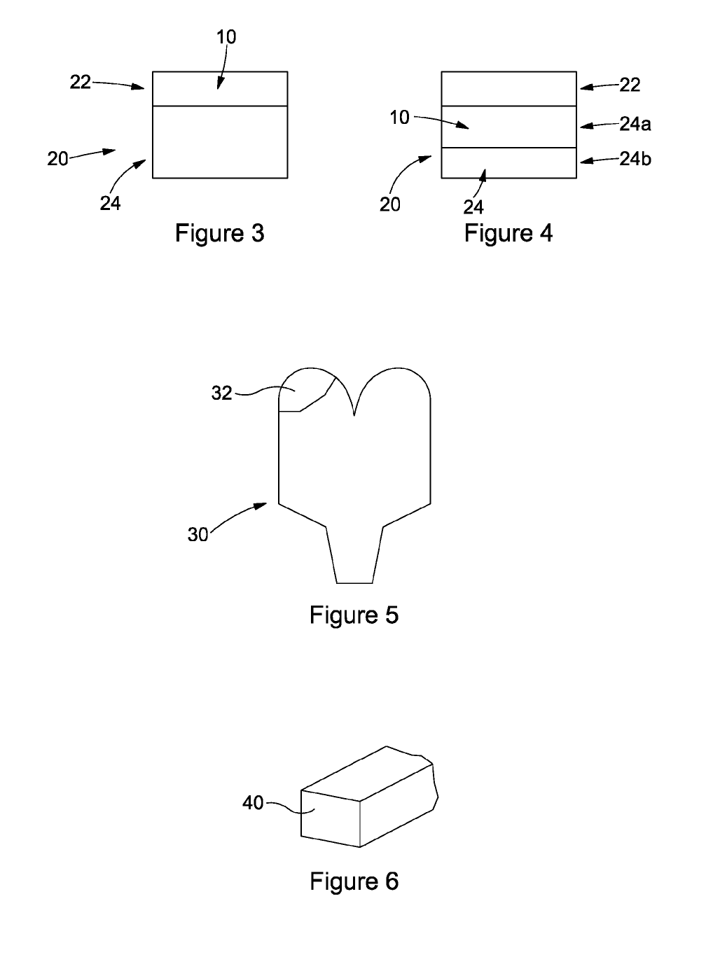

By way of example, FIGS. 3 and 4 illustrate two forms of cutting element 20 in which structures 10 of the type described hereinbefore may be employed. In the arrangement of FIG. 3, the structure 10 is incorporated into the diamond table 22 of the cutting element 20, the substrate 24 thereof taking the conventional tungsten carbide form. Whilst as illustrated, the structure 10 forms the entirety of the diamond table 22, this need not always by the case and arrangements are possible in which only part of the table 22 may take this form. By way of example, it may not extend to the periphery of the cutting element.

The materials used in the formation of the structure 10 of the arrangement of FIG. 3 may comprise, for example, a diamond material element 12 and a diamond material powder 16, treated by sintering under high temperature, high pressure conditions in the presence of a suitable catalyst. As mentioned hereinbefore, the diamond material element 12 may itself comprise a graphite skeleton, for example formed through the pyrolysis of a suitable organic material, a diamond material coating having been applied thereto using a suitable CVD technique.

It is envisaged that a structure of the type shown in FIG. 3 may be advantageous in that the CVD deposited diamond material will typically be of considerably higher thermal conductivity than the sintered diamond material. CVD deposited diamond is typically of reduced mechanical durability than sintered diamond, but the sintered diamond can provide support for the CVD deposited diamond in this structure. Accordingly, the embodiment of FIG. 3 may permit the provision of a cutting element of enhanced thermal conductivity without significantly impairing the strength characteristics thereof.

Whilst not illustrated, it is also envisaged that the structure 10 may include a part in which the element 12 contains powder 16 in the form of a diamond material, and another part in which the powder 16 is in the form of tungsten carbide powder, the structure having been treated by sintering, the structure extending into the substrate 24. Such an arrangement may enhance the conduction of thermal energy from the table 22 into the substrate 24.

FIG. 4 illustrates an arrangement in which the structure 10 forms a part 24a of the substrate 24. In this arrangement, the substrate 24 also includes a region 24b of conventional tungsten carbide form, but this need not always be the case. In this arrangement, the element 12 may be of tungsten carbide form, and the powder 16 may be of diamond form, treated by sintering. Such an arrangement may be advantageous in that the sintered powder 16 may assist in the conduction of thermal energy away from the table 22. Bonding of the diamond table 22 to the substrate 24 may further be enhanced by the provision of the structure 10.

The structure 10 of the type used in the arrangement of FIG. 4 could, if desired, be modified by, after sintering, leaching the structure 10 to remove the tungsten carbide material of the element 12 therefrom. Such a structure would be of porous form. Potentially, such a structure could be used to aid cooling in that a suitable coolant could be passed through the pores of the structure 10. Alternatively, by appropriate selection of the material of the element 12, the pores of the structure 10 may be of a controlled size, and the structure 10 may be used as a filter with good wear resistance characteristics and suitable for use in relatively high temperature conditions.

FIG. 5 illustrates, schematically, a bit body 30 of a rotary drill bit. The bit body 30 may be of the type to which cutting elements are secured, or may be of a material incorporating abrasive, for example, diamond material, particles. The bit body may be formed by infiltration of a material powder located within a mould using a suitable molten alloy.

In the arrangement of FIG. 5, prior to the introduction of the material powder into the mould, an element 12 has been located in a part of the mould in which a part 32 of the bit body 30 thought to require reinforcement is to be formed. During the subsequent introduction and packing of the powder material into the mould, some of the powder material 16 flows into and through the cells 14 of the element 12. During the subsequent infiltration operation, the powder 16 located within the cells 14 is infiltrated by the molten alloy material simultaneously with the infiltration of the remainder of the bit body 30. In this arrangement, it is thought that the use of a metallic foam material element 12, possibly coated with tungsten carbide, will serve to enhance the fracture resistance of the part 32 of the bit body 30 in which it is located. Whilst FIG. 5 illustrates one region in which the element 12 may be located, it will be appreciated that the claimed invention is not restricted to the location of the element 12 in this region of the bit body 30, and that it may be located elsewhere without departing from the scope of the claimed invention.

Another application in which the embodiments disclosed herein may be employed is in the manufacture of an abrasive material 40 (see FIG. 6). The abrasive material 40 comprises an element 12 of diamond or diamond coated material form as described hereinbefore, infiltrated with a metallic material. Prior to infiltration, the cells of the material 40 may be filled with a powder material 16 such as tungsten carbide. It is envisaged that a material 40 of this type will be highly abrasive whilst being of good wear resistance. The material 40 could be used in the formation of, for example, cutting elements for use on rotary drill bits.

In any of the arrangements described hereinbefore, the element 12 may be of substantially uniform density. Alternatively, the element 12 may be of, for example, graded form or be otherwise of non-uniform density. By way of example, a controlled crushing load may be applied to the element 12 prior to the application of the powder material 16 thereto, resulting the in the periphery of the element 12, in the regions which the crushing load is applied, being of increased density and so having a smaller cell volume that elsewhere. Another technique that may be adopted to achieve this result is to use graded density materials, for example fabricated by additive manufacturing, as the element 12.

The material of the element 12 may take a range of forms and structures. As described hereinbefore, it may be of a range of materials and cell sizes. The cells 14 of the element may have an average pore dimension falling within the range of, for example, 0.35 to 2 mm, with the surface area of the material of the element 12 falling within the range of 1600 to 6900 m² per m³. It will be understood, however, that other materials may be used without departing from the scope of the claimed invention.

It is important to note that, in the fabrication method described hereinbefore, a powder material is introduced into the cells of a prefabricated, preexisting or preformed open cell foam element. This is quite unlike the known fabrication techniques in which a binder catalyst material and diamond powder or the like are sintered under high temperature, high pressure conditions to form a network of bonded diamond grains and a network of interstices, at least some of which may contain the binder catalyst material. In these known methods, there is no step of applying a powder material to the cells of an existing open cell foam element. The fabrication method of the claimed invention is thus very different to known fabrication techniques. Furthermore, in general, structures fabricated using the method will be quite unlike structures fabricated using the known techniques.

Whilst specific example embodiments are described hereinbefore, it will be appreciated that a wide range of modifications and alterations may be made thereto without departing from the scope of the invention, which is defined by the appended claims. Whilst, primarily, the description hereinbefore relates to structures intended for use in downhole applications, for example in applications related to the extraction of hydrocarbons, the claimed invention is not restricted in this regard.

1. A method of fabrication of a structure, the method comprising:
providing an open cell foam element of metallic, diamond, ceramic and/or refractory material form, and/or having one or more metallic, diamond, ceramic and/or refractory material coatings, the foam element defining a plurality of interconnected cells;
locating a material within the cells; and
treating the material, in situ, by sintering and/or infiltration, to form a continuous mesh or lattice structure extending within and through the cells of the open cell foam element.

2. A method according to claim 1 wherein the foam element is of metallic form and the method further comprises a step of leaching the metallic material of the foam element.

3. A method according to claim 1, wherein the cells of the foam element are irregularly arranged, and the mesh or lattice structure is an irregular mesh or lattice.

4. A method according to claim 1, wherein the cells of the foam element are regularly arranged, and the mesh or lattice structure is of regular form.

5. A method according to claim 1, wherein the foam element is of pyrolysed organic material form, provided with a metallic, diamond, ceramic and/or refractory material coating.

6. A method according to claim 5, wherein the coating is applied using a CVD technique.

7. A method according to claim 1, wherein the foam element is of 3D printed construction.

8. A method according to claim 1, wherein the foam element has an average pore dimension falling within the range of 0.35 to 2 mm.

9. A method according to claim 1, wherein the foam element has a surface area falling within the range of 1600 to 6900 m² per m³.

10. A method according to claim 1, wherein the foam element is of substantially uniform density.

11. A method according to claim 1, wherein the foam element is of graded density.

12. A structure comprising:
an open cell foam element of metallic, diamond, ceramic and/or refractory material form, and/or provided with one or more metallic, diamond, ceramic and/or refractory material coatings, the element defining a plurality of interconnected cells; and
a material located within the cells, the material having been treated, in situ, by sintering and/or infiltration, to form a continuous mesh or lattice structure extending within and through the cells of the open cell foam element.

13. A structure according to claim 12 and forming part of a downhole tool.

14. A structure according to claim 13, wherein the downhole tool comprises a drill bit.

15. A structure according to claim 14, and forming a part of a bit body of the drill bit.

16. A structure according to claim 14, and forming a part of a cutting element of the drill bit.

17. A structure comprising:
an open cell foam element defining a plurality of interconnected cells;
tungsten carbide material located within the cells; and
an alloy infiltrated into the tungsten carbide material in the cells such that the infiltrated tungsten carbide material forms a continuous lattice structure extending within and through the cells of the open cell foam element.

18. A structure according to claim 17 and forming part of a bit body of a downhole tool.

19. A manufacturing method for use in the manufacture of the structure of claim 17, the method comprising:
providing an open cell foam material element defining a plurality of interconnected cells;
locating a tungsten carbide material within the cells; and
infiltrating an alloy into the tungsten carbide material in the cells such that the infiltrated tungsten carbide material forms a continuous lattice structure extending within and through the cells of the open cell foam element.

20. A method according to claim 19, wherein the foam material element is placed within a mould for a bit body prior to the introduction of tungsten carbide powder material into the mould.

21. A structure comprising a metallic or refractory material open cell foam element defining a plurality of interconnected cells and diamond material located within the cells, the diamond material having been sintered, in situ, to form a lattice structure extending within the cells of the open cell foam element.

22. A structure according to claim 21 and forming a cutting element of a downhole drill bit.

23. A manufacturing method for use in the manufacture of the structure of claim 21, the method comprising:
providing a metallic or refractory material open cell foam element defining a plurality of interconnected cells;
locating a diamond material within the cells; and
sintering the diamond material, in situ, to form a lattice structure extending within the cells of the open cell foam element.

24. A structure comprising an open cell foam diamond material element defining a plurality of interconnected cells, and a second diamond material located within the cells, the second diamond material having been sintered, in situ, to form a continuous lattice structure extending within the cells of the open cell foam element.

25. A method of manufacture of the structure of claim 24, the method comprising:
providing a structure comprising an open cell foam diamond material element defining a plurality of interconnected cells;
locating a second diamond material within the cells; and
sintering the second diamond material, in situ, to form a lattice structure extending within the cells of the open cell foam element.

26. A structure comprising a diamond material open cell foam element defining a plurality of interconnected cells, and a material infiltrated into the cells such that the infiltrated material forms a continuous lattice structure extending within and through the cells of the open cell foam element.

27. A structure according to claim 26 and adapted for use as an abrasive material.

28. A method of manufacture of the structure of claim 26, the method comprising: providing a diamond material open cell foam element defining a plurality of interconnected cells, and infiltrating a material into the cells such that the infiltrated material forms a continuous lattice structure extending within and through the cells of the open cell foam element.
